(19) United States
(12) Patent Application Publication
(10) Pub. No.: US 2014/0351078 A1
(43) Pub. Date: Nov. 27, 2014

(54) Systems and Methods for Recommending Products

(71) Applicant: Wal-Mart Stores, Inc., Bentonville, AR (US)

(72) Inventors: Julia Kaplan, Redwood City, CA (US); Alice Au Quan, San Francisco, CA (US); Zoltan Rajeczy von Burian, San Francisco, CA (US)

(21) Appl. No.: 13/903,761

(22) Filed: May 28, 2013

Related U.S. Application Data
(60) Provisional application No. 61/827,283, filed on May 24, 2013.

(51) Int. Cl. G06Q 30/06

(52) U.S. Cl. CPC G06Q 30/0631
USPC 705/26.7

(57) ABSTRACT

Computer-implemented systems and methods include generating, from an inventory of products for sale at a retailer, a list of recommended products corresponding to a set of product types implicated by one or more designated product categories, a total selling price of the recommended products being within a designated shopping budget. The computer-implemented systems and methods may further include displaying the list of recommended products to a user.

### CROSS-REFERENCE TO RELATED APPLICATION

This application claims priority to and benefit of U.S. Provisional Patent Application No. 61/827,283, filed May 24, 2013, the disclosure of which is incorporated herein by reference in its entirety.

### BACKGROUND

Embodiments of the disclosure relate generally to data processing, and more particularly to systems and methods for generating and/or displaying lists of products recommended for purchase based at least in part on a shopping budget and a designation one or more product categories.

Increasingly, people are utilizing Internet-based services to perform routine tasks, including shopping. For example, computer-based applications exist for identifying, selecting and purchasing merchandise that is for sale in a traditional brick and mortar retail store, through an electronic commerce (“e-commerce”) website, or both. Such applications may retrieve, via the Internet or other network, data from a merchant for displaying various items that are available for purchase, along with the corresponding selling prices. Customers may use these applications to search or browse for items having particular characteristics, such as model or brand name, product description, size, color, feature set, and/or a variety of other identifying characteristics.

### SUMMARY

Computer-implemented systems and methods are presented which generally involve generating, from an inventory of products for sale at one or more retailers or deliverable to a customer, a list of recommended products corresponding to a set of product types implicated by one or more designated product categories, a total selling price of the recommended products being within a designated shopping budget. The computer-implemented systems and methods may further include displaying the list of recommended products to a user. User controls and/or data mining may be utilized to receive input data relating to the one or more product categories and the shopping budget. In some embodiments, the input data may characterize a purpose for the shopping excursion and may be used to identify one or more solutions each including a set of one or more product categories. A user may then designate a set of one or more categories by selecting one of the solutions.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram representing an example of a system for automatically generating product recommendations in accordance with some embodiments;

FIG. 2 depicts an example of a user interface, in accordance with some embodiments, for designating one or more product categories and a budget;

FIG. 3 depicts an example of a user interface, in accordance with some embodiments, for displaying recommended products;

FIG. 4 is a flow diagram of a computer-implemented process for recommending items in accordance with some embodiments;

FIG. 5 is a block diagram of an example of a system for carrying out one or more embodiments; and

FIG. 6 is a block diagram of an exemplary client-server environment for implementing one or more embodiments.

FIG. 7 depicts another example of a user interface, in accordance with some embodiments, for designating one or more product categories and a budget.

FIG. 8 depicts an example of a user interface, in accordance with some embodiments, including a plurality of solutions each associated with one or more product categories.

FIG. 9 depicts another example of a user interface, in accordance with some embodiments, for displaying recommended products;

### DETAILED DESCRIPTION

According to various embodiments, computer-implemented systems and methods are disclosed for automatically generating product recommendations, for example, from products in a store inventory, based on user designations of one or more product categories and a budget. In exemplary embodiments, the recommended products correspond to a set of products in the designated product categories having a total price that is within the specified shopping budget. In some embodiments, the user may interactively adjust the spending budget using a graphical user interface (GUI) element that allows the user to increase or decrease the budget. In some embodiments, as the spending budget is adjusted, the product recommendations may automatically change to reflect the change in budget. For example, if the budget is decreased, similar but lower-priced products and/or fewer products may be recommended and displayed to the user. Alternatively, if the budget is increased similar but higher priced products and/or more products may be recommended and displayed to the user.

Online-based technologies have enabled people to use the Internet for shopping. For example, a customer may use the Internet to locate and obtain the price and availability of merchandise sold by a particular retailer, such as groceries, household goods, tools, electronics, toys, clothing, garden supplies, books, movies, music, etc. Such information may be used to build an electronic shopping list that the customer can carry into a store (for example, on a mobile computing device).

One limitation of some electronic shopping list applications is that they do not automatically take into account the customer's spending budget. If the application does not account for the customer's spending budget, the customer must make mental choices about which items can be purchased within their budget, or use other means for determining which products can be purchased within the budget. For instance, the customer may reach his or her budgeted spending limit before all of the items on the shopping list that the customer wishes to purchase have been accounted for. This may occur if some of the items on the customer's shopping list are more expensive than other similar items that the customer could instead purchase from the merchant. As an example, if the customer has a name brand tube of toothpaste in his or her shopping list, that product may be more expensive than a generic, unbranded tube of toothpaste. If the customer notices this price difference while shopping, he or she may be inclined to purchase the unbranded toothpaste instead of the name brand toothpaste to save some money and help keep expenses within budget. However, this process requires the customer to manually perform additional research and/or calculations, which is inefficient and inconvenient. As a consequence, the customer may not end up purchasing the optimum combination of products within his or her spending budget.

A further disadvantage of some electronic shopping list applications is that compiling and creating a shopping list is time consuming and at times difficult for customers particularly, when they are purchasing a large quantity of products, for example, for furnishing a new apartment, planning a wedding, etc. Moreover, customers are prone to forget or omit necessary items from the list thereby throwing off both their budget and requiring additional efforts. Again, as a consequence the customer may not end up purchasing the optimum combination of products within his or her spending budget.

Advantageously, the systems and methods disclosed herein allow the user to designate one or more product categories and a budget. A processor then automatically generates a recommended combination of products within his or her spending budget, for example, to fulfill the user's need based on a fixed or variable budget input. This saves the user both time and effort creating a shopping list as well as enable the user to purchase a more optimal combination of products.

The term “product,” as used herein, may refer to any good or service. Goods may include both physical goods as well as digital goods (such as software and digital media). Exemplary broad categories of goods may include but are not limited to, home goods, apparel and accessories, electronics, sports fitness and outdoor goods, pharmaceutical health and beauty goods, groceries, movies, music, books, toys and games, automotive goods, home improvement goods, goods for parties/occasions, goods for crafts or hobbies, and the like. Services may include services tied to particular goods (such as warranties, service agreements, product support, and the like) as well as services that are not tied to particular goods. Exemplary broad categories of services may include moving storage and shipping services, warranty services, event services (such as catering, performances, etc.), travel services, lodging services, food services, activity services, attraction services, creative services, printing copying and mailing services and the like. The term item is at times herein used synonymously with the term product.

The term “product inventory,” as used herein, refers to the domain of products from which product recommendations may be returned. The product inventory may be a product inventory for a particular retail location or company or may be an aggregate of product inventory for plurality of retail locations and/or companies. Thus, in exemplary embodiments, the user may designate a product inventory, for example, by selecting one or more retail locations and/or companies, for example, by entering a particular location and scope (such as retail locations and/or companies within X miles/minutes of Location Y or that ship to Location Y). Alternatively, geolocation and other data mining algorithms may be used to automatically select the one or more retail locations and/or companies (for example, based on favorite retail locations and/or companies as determined via mining social media service, utilizing browser tracking cookies, and the like). In some embodiments, the product inventory may be limited by an availability parameter. Thus, the product inventory may include, for example, only products that are currently in stock in the selected retail locations and/or companies, only products that are available for in store pick-up, only products that are available to ship, only the products which are available in X time, or other similar subsets of products passed on availability criterion, for example, designated by the user.

The term retailer as used herein refers to any entity or entities involved in the sale of a product inventory. Thus, a retailer may be a traditional brink and mortar retailer, an online retailer or both. A retailer may include one or more retail locations and/or companies. Also, a retailer may include a marketplace for third parties sellers, for example, as an online auction website such as eBay™, or product listing site such as Amazon.com™ or Craigslist™.

The term “recommended product,” as used herein refers to a product in the subset of products returned from the product inventory by the systems and methods of the present disclosure as a product recommended for purchase by the user. The systems and methods advantageously generate product recommendations based selected and/or generated criterion including at least a user designation of one or more budget parameters and a user designation of one or more product categories. Thus, for example, the recommended products may include a subset of products returned from the product inventory products related to the designated product categories and meeting the designated budget constraints. In exemplary embodiments, the systems and methods provide for quick and easy purchasing of the recommended products following the generation thereof, for example, one-click to send current version of recommended products list to the shopping cart and the like.

The term “product type,” as used herein refers to a group of products that are substantially related to one another, for example, so as to be considered substitute products (such as, different brands of jeans, different types of floor lamps or different laptop models, different packaging quantities of bars of soap, different thread count sheets, and the like). In exemplary embodiments, the systems and methods of the present disclosure rely on a product type classifier to commonly classify products as a single product type.

The term “product category,” refers to a conceptual abstraction relating a plurality of different types of products based on a common concept/theme. In the context of the systems and methods of the subject application, a product category may relate a plurality of product types which are typically purchased under a common budget. In exemplary embodiments a product category may include a category of goods or services based on common ties to a particular event, activity, location, aesthetic, project or the like. Thus, for example, designating one or more categories may include designating one or more areas of the house such as a new nursery, boy's room, girls room, bathroom, seasonal, etc., or of an apartment, dorm room, or other location, for decorating and/or furnishing, events such as a wedding, dinner party, birthday, bridal shower, baby shower and the like, activities such as a camping expedition or a vacation, aesthetics themes such as related to particular era or style, projects such as home repair/renovation projects and the like. In exemplary embodiments, each designated product category may be associated with a predetermined set of one or more product types. Thus, for example, product categories for bedroom furniture may be associated with beds, dressers, armoires, mattresses, nightstands, vanities, etc. Thus, one or more designated product categories may each implicate a set of one or more product types for purchase.

User input and/or data mining information may be utilized in the designation of the one or more product categories. In the simplest embodiments, a user may merely select one or more product categories from a list of product categories. In some embodiments, a user may designate one or more product categories by providing user input regarding the purpose of the shopping excursion, for example, using a decision tree model. The provided information may then be used to automatically select/implicate one or more product categories. Thus, for example, a user may provide indicate that he or she is looking to purchase equipment for a three day hiking/camping excursion during the winter. Notably, there may be multiple product categories for hiking/camping excursions each characterized by different sets of one or more product types depending on the season and duration of the excursion. Thus, the additional information regarding the season and duration may aid in selecting an appropriate product category, for example, a cold weather short period hiking/camping excursion.

In some exemplary embodiments, information provided by the user may be supplemented with data mining information, for example, regarding age, gender, hobbies and the like, to facilitate designation of an appropriate product category. For example, if social media information for the user in the above hiking/camping excursion example indicates an interest in fishing, the automatically designated product categories may include ice fishing supplies for the hiking/camping excursion.

In exemplary embodiments, one or more possible solutions each including a set of one or more recommended product categories may be automatically generated based on user input and/or data mining information. A user may then designate the one or more product categories by selecting and/or customizing one or more of the offered solutions. In exemplary embodiments, a user may preview product categories associated with each of the offered solutions, for example, to facilitate comparing solutions.

In exemplary embodiments, the one or more product categories and/or one or more product solutions may be selected based in part on budget information. Thus, using the above hiking/camping example, there may be multiple product categories for hiking/camping excursions each characterized by different sets of one or more product types depending on the budget range. For example, a product category for a low budget excursion may include only essential product types whereas a product category for a higher budget excursion may include some additional non-essential product types. In alternative embodiments, each product type implicated by a designated product category may be associated with a weighting factor, e.g., indicating importance and/or cost relative to the other product types implicated by the product category. Thus, depending on the budget one or more of the product types may be cut from the list of recommended products, for example if all product type(s) could not be satisfied under the budget constraints. For example, the least important product type(s) may be cut. In some embodiments, the least number of product type(s) under a threshold level of importance or the most expensive product type(s) under a threshold level of importance may be cut. In some embodiments, the least important combination of the least number of product types under a threshold level of importance may be cut.

In exemplary embodiments, product category criterion designated by the user may be supplemented or augmented by criterion automatically generated via data mining algorithms (for example, based on favorite brands, or aesthetic preferences as determined via mining social media service, utilizing browser tracking cookies, and the like). In exemplary embodiments, each of the selected product categories may automatically or by user input be assigned weighting factor(s), for example, reflecting the relative importance and/or relative expected cost of the category. In some embodiments, the weighting factor(s) may reflect a portion or percentage of the budget as assigned to that particular category. Thus, the selected and/or generated criterion including the user designated budget constraints and the user designated product categories may, by the systems and methods of the present disclosure, be used to query the product inventory and return product recommendations. Various algorithms/techniques may be used to process the query including for example vertical querying, horizontal querying, regression techniques, applying a decision tree model, applying a neural network model, applying machine learning techniques such as support vector machines (SVM) and the like. In exemplary embodiments, a distributed architecture may be used to optimize processing efficiency/speed.

In exemplary embodiments, the systems and methods of the present disclosure may generate one or more lists of recommended products meeting the designated budget constraints for sets of product types implicated by each of the designated one or more product categories. User input and/or data mining information regarding desired, required, or optimal product characteristics may also be used to limit which products are included as recommended products and or rank/compare different recommended product lists. For example, prior purchasing patterns by the user or users in general may facilitate ranking generated lists of recommended products. Gender, age, and aesthetic information may also be used in generating appropriate (for example, aesthetically appealing, age and gender appropriate) recommended product list(s) and/or in ranking generated lists. Time constraints may also be considered, for example, to exclude from the recommended products items that are out of stock or unavailable prior to a certain date. Note that time constraints may also be factored in when calculating appropriate shipping costs for budgeting purposes.

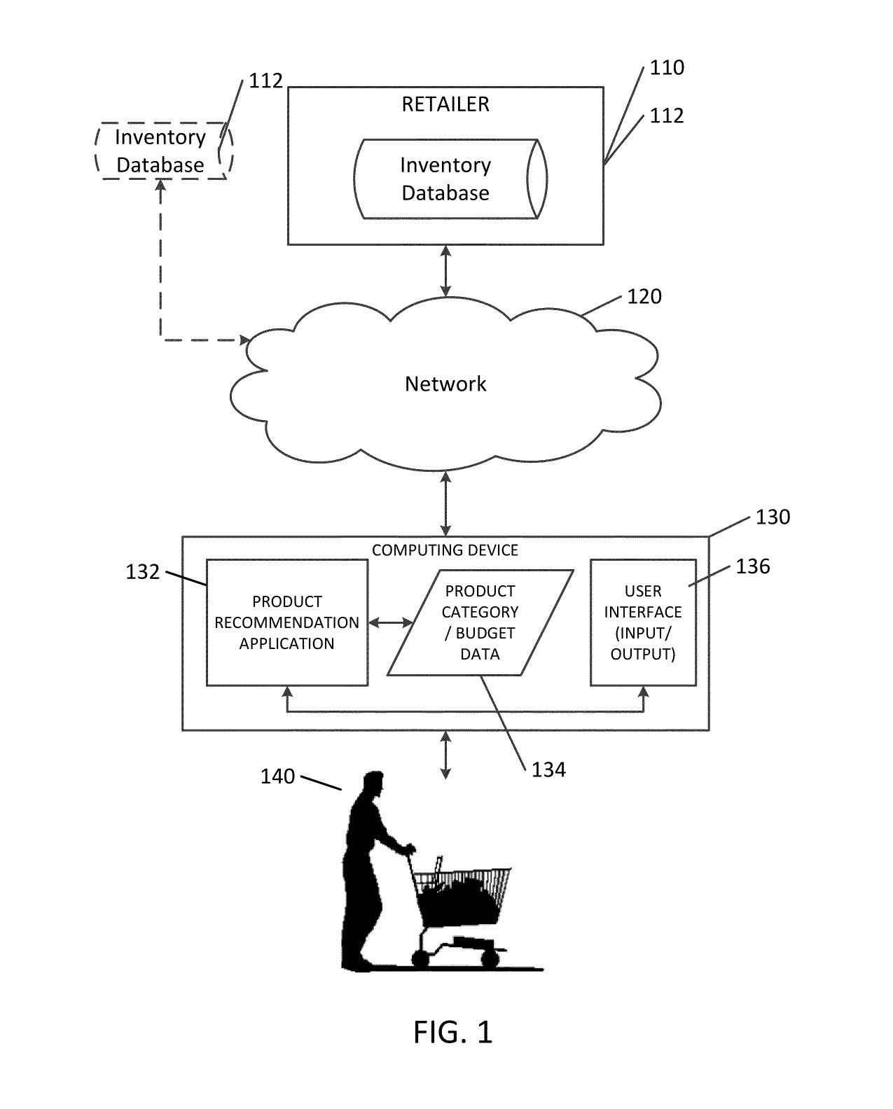

FIG. 1 is a block diagram representing an example of a system for automatically generating product recommendations according to a desired shopping budget. A retailer 110 stocks an inventory of items, which is tracked in an inventory database 112. A network 120, which may include, for example, the Internet, provides a connection for exchanging data between the inventory database 112 and a computing device 130. The computing device 130 may include a computer, mobile computing device, or other computing device having a processor configured to execute a product recommendation application 132. The computing device 130 may include a memory configured to store product category criterion list and budget data 134 (for example, as one or more data structures), and a user interface 136 operatively connected to the processor executing the product recommendation application 132. The user interface 136 may include a GUI for receiving user inputs and displaying information, such as a list of recommended products, as well as user controls and other GUI elements. A shopper 140, also referred to herein as a user, interacts with the product recommendation application 132 using the computing device 130.

The computing device 130 and the retailer 110 can be interconnected to share and exchange data through the network 120, which may include servers, databases, routers, switches, intranets, the Internet, and other computing and networking components and resources. Network link(s) between the computer device 130 and the inventory database 112 may include any arrangement of interconnected networks including both wired and wireless networks. For example, a wireless communication network link over which the computing device 130 communicates may utilize a cellular-based communication infrastructure that includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, the network links may include wireless technologies including WLAN, WiFi®, WiMAX, Wide Area Networks (WANs), and Bluetooth®. At least a portion of user data, including the product category/budget data 134, can be stored in one or more databases connected to, or incorporated within, the network 120, such that the user data may be accessed directly or indirectly from various computing resources, such as the computing device 130 and/or the inventory database 112. The inventory database 112 may also be located off site from the retailer 110 at a different geographical location.

The computing device 130 may include any computing device, such as a personal computer (PC) or a mobile computing device (for example, smart phone, tablet computer, or personal digital assistant) that is configured to connect directly or indirectly to the network 120 and/or the inventory database 112. Examples of user devices include a smartphone (for example, the iPhone® manufactured by Apple Inc. of Cupertino, Calif., BlackBerry® manufactured by Research in Motion (RIM) of Waterloo, Ontario, any device using the Android® operating system by Google, Inc. of Mountain View, Calif., or any device using the Windows Mobile® operating system by Microsoft Corp. of Redmond, Wash.), a personal digital assistant, or other multimedia device, such as the iPad® manufactured by Apple Inc. In another example, the computing device 130 may be included in a touchscreen in-store kiosk, which may enable a user select product category and budget criterion and view a list of recommended products based on such selectons. The computing device 130 may connect to other components (for example, network 120 and/or the inventory database 112) over a wireless network, such as provided by any suitable cellular carrier or network service provider (for example, Sprint PCS, T-Mobile, Verizon, AT&T, etc.), or via a WiFi® connection to a data communication network. In exemplary embodiments, the computing device 130 is a mobile computing device provided by the retailer for use while shopping, as opposed to a device owned by the customer. Such a device may be a conventional mobile device (for example, an iPhone® or iPad®).

The inventory database 112 includes data representing the items for sale in the retailer 110. The data may include, for example, product names, identification numbers (for example, item numbers, universal product codes, etc.), and prices and/or quantities associated with each item in inventory. The data may also include product classification information for the same product type. For example, several different types, sizes, qualities and/or brands of a particular good (such as, Brand A sheets, Brand B sheets, 100 thread count sheets, 400 thread count sheets, etc.) may each be classified as the same product type using a product type classifier (such as “sheets” or “sheet sets”) which is stored in the inventory database 112.

The data may also include product category classifications for relating different types of products. In some embodiments, the inventory database 112, or another database, includes sale or discount price information for one or more products in the inventory database 112. For example, coupon or instant savings amounts corresponding to certain products may be stored in the inventory database 112. The database may also store information relating to availability and/or shipping of the products (note that the shipping costs may be highly relevant to enabling accurate comparisons of product costs, for example, where products may ship for different prices or where some products may be available for in-store pick-up and others may be available for shipping only).

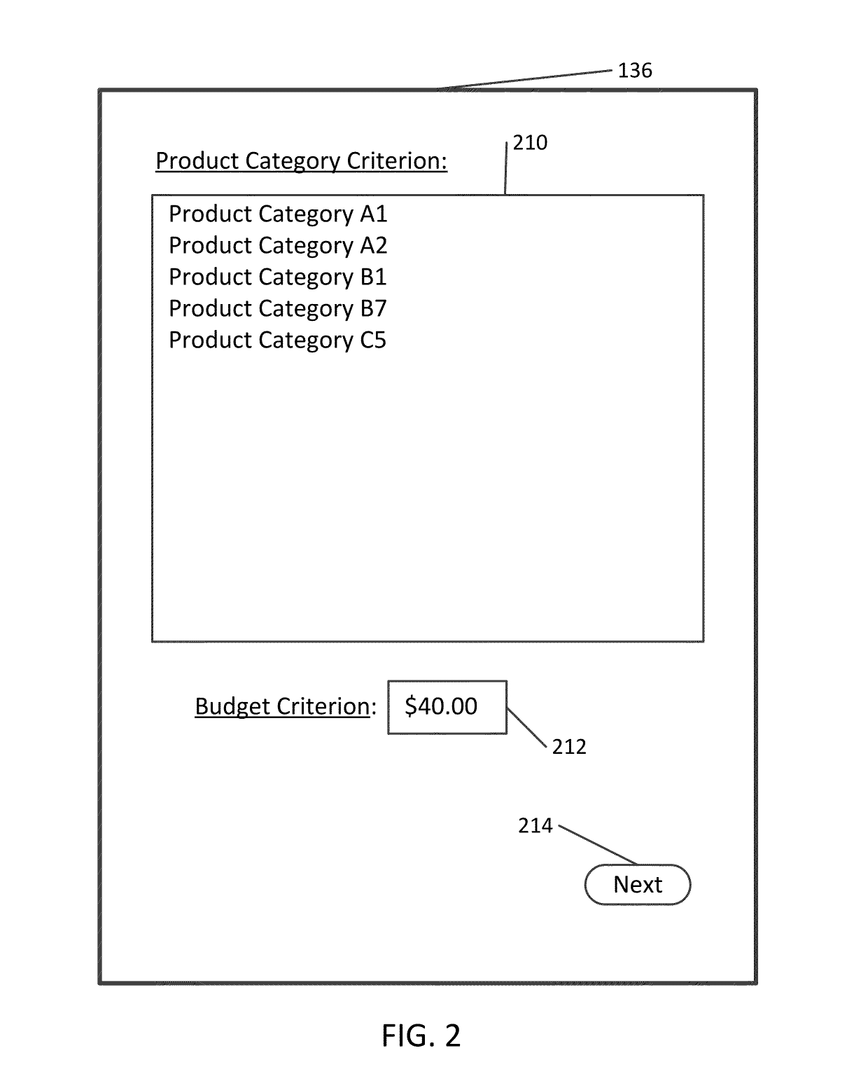

FIG. 2 depicts an example graphical user interface 136 of FIG. 1 that may be used in conjunction with the computing device 130 according to exemplary embodiments. The user interface 136 can be configured and/or programmed to enable user 140 to designate product category criterion 210 and budget criterion 212 which may each be stored in the data 134. For example, the designated product category criterion 210 may include product category classifiers A1, A2, B1, B7 and C5. Product category classifiers for the product category criterion 210 may, for example, be entered, modified and/or removed by the user 140 using GUI elements of the user interface 136, and/or stored in the data 134. Exemplary GUI elements which may be used include text boxes, sliders, pull down menus, check boxes and the like.

In exemplary embodiments, the product recommendation application 132 may be limited to a particular purpose, for example, decorating, furnishing and/or renovating one or more areas of the home, event planning (such as for a wedding, dinner party, etc.), vacation or trip planning (such as travel, lodging, activities, etc.), activity planning (such as fishing, camping, picnicking, etc.) and the like. Thus, the user may be limited to selecting product categories relating to only a single purpose, for example, decorating, furnishing and/or renovating one or more areas of a house. Moreover, the user may be limited to selecting product categories relating to only a single category type (for example, which areas of the house are to decorated, furnished and/or renovated) or may select product categories relating to different category types (for example, which areas of the house and with what aesthetic qualities/themes such as a favorite decor style). In some embodiments the product recommendation application 132 may be limited to a user selecting (for example, automatically selecting by executing the application) a single product category (for example, decorating, furnishing and/or renovating, a particular room).

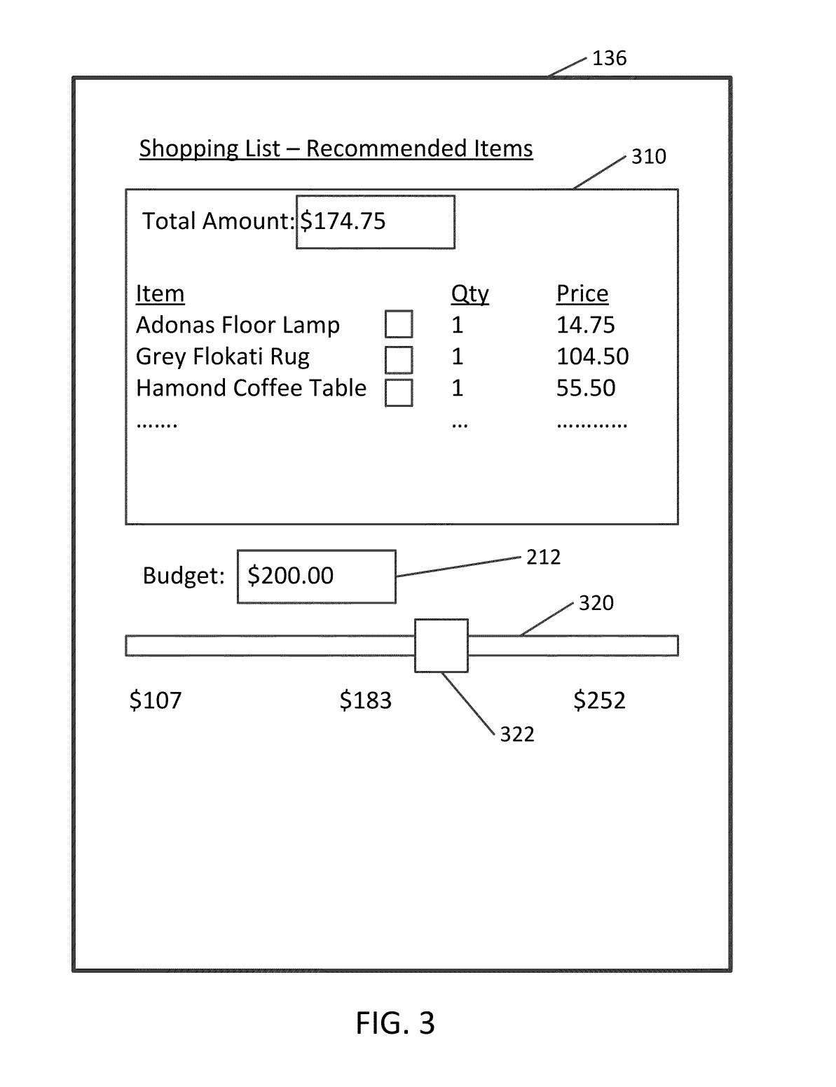

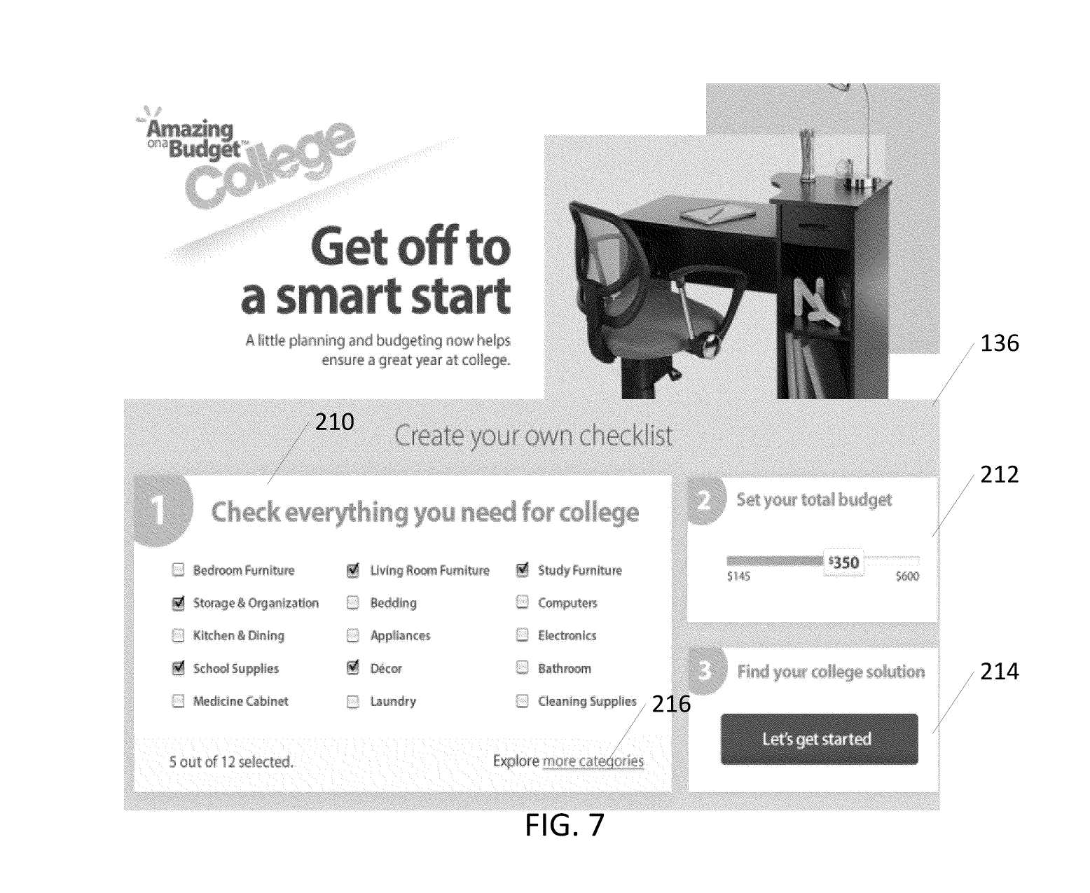

FIG. 7 depicts an exemplary graphical user interface 136 of FIG. 1 that may be used in conjunction with the computing device 130 according to exemplary embodiments. The user interface 136 of FIG. 7 is an illustrated example of the user interface 136 of FIG. 1. The illustrated user interface 136 includes a first window including an array of checkboxes for allowing a user to select one or more product categories 210, a second window including a sliding scale for allowing a user to select a budget 212 and a third window including a control button 214 for initiating a query. The sliding scale in FIG. 7 may be similar to the sliding scale described with respect to FIG. 3. Thus, the sliding scale for selecting the budget 212 may advantageously including minimum and maximum values for previewing minimum and maximum budgets possible for the selected product categories. The user interface 136 may further include a control button 214 for initiating a query based at least in part on the inputted product category criterion 210 and the inputted budget criterion 212 the result of which is one or more lists of recommended products. In exemplary embodiments, the product category selection window 210 may include a control for exploring options for more product categories 216. In exemplary embodiments, a visual preview of the item types implicated by the selected categories, for example a preview of the furnishings being added to each room may be depicted to provide an immersive aesthetic experience for the user when selecting the categories.

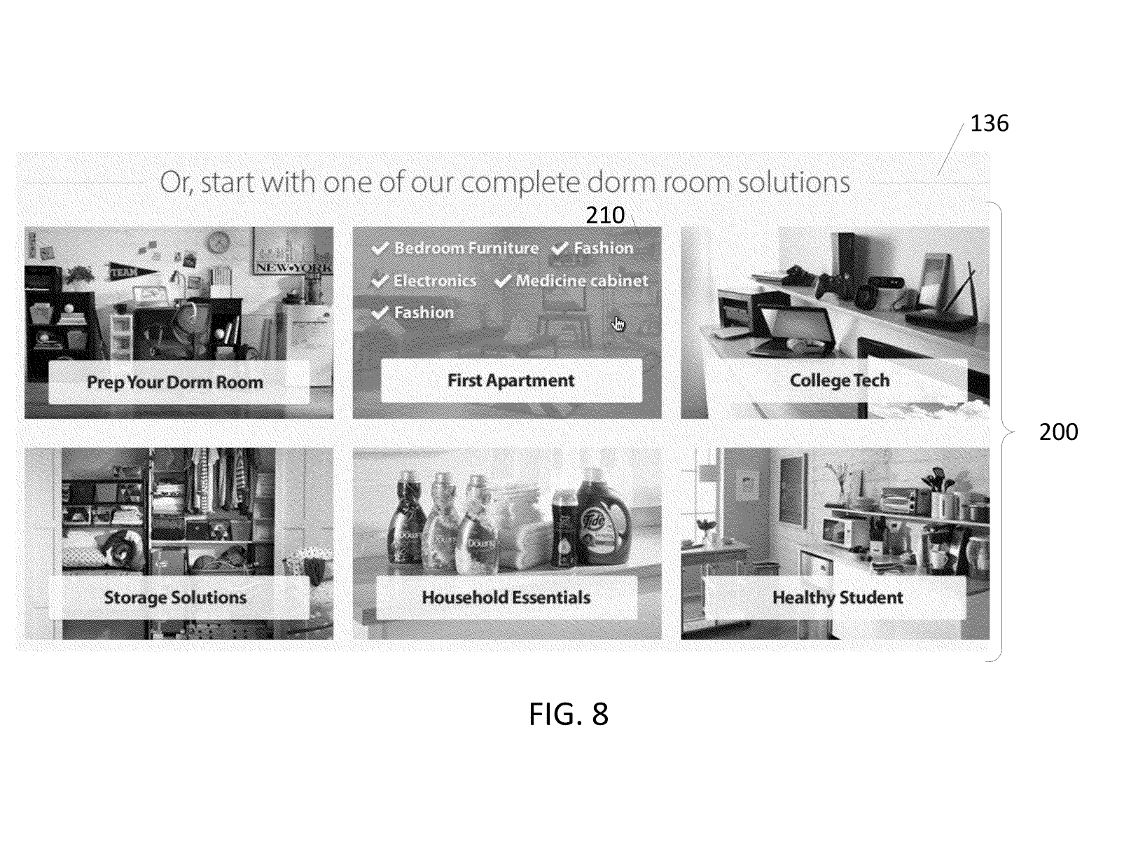

With reference again to FIG. 2, in exemplary embodiments, the product recommendation application 132 may offer/recommend combinations of one or more product categories as quick solutions for a particular problem. Thus, for example, a user may be presented with one or more solutions, e.g., for selection of common groupings of product categories. For example, the product recommendation application 132 may include a variety of dorm room solutions such as a solution for a first apartment, a solution for household essentials (cleaning supplies, laundry supplies, etc.), a solution for college tech (for example, media system, computer system, etc.), a solution for storage (for example, shelving systems, bins and labels, hangers and other closet organizers, etc.), a solution for decorating a dorm room (for example, school pride, frames and posters, pillows and occasional etc.) and the like. Each solution may be characterized by a group of one or more product categories associated with the solution. In exemplary embodiments, a user may preview which product categories are associated with which solutions, for example, by hovering a pointer over a particular solution. In exemplary embodiments, a solution may contain and/or represent a single product category. FIG. 8 depicts an exemplary embodiment of a user interface 136 providing a plurality of solutions 200 for selecting a group of one or more product categories 210. Note that the one or more categories associated with each solution are able to be previewed, for example by hovering over the solution. The use, in FIG. 3, of solutions 200 in designating one or more product categories 210 is one illustrated example of a product category criterion selection window 210 for a user interface 136 according to the present disclosure, for example for the user interface 136 of FIG. 2.

Referring again to FIG. 2, the product recommendation application 132 may also be more generalized allowing a more free-flowing selection of category classifiers, e.g., relating to different but related purposes (for example, furnishing a dorm room and buying school supplies) or even completely unrelated purposes (for example, buying a new home entertainment system and planning for a family camping trip). The common denominator is to allow the user to easily and quickly designate one or more product categories which share a common budget. Thus, for example, a student often may have a single budget which to furnish his or her dorm room, purchase school supplies, and purchase food/snacks, etc. In exemplary embodiments, the user interface 136 may implement a decision tree model or the like for determining the purpose(s) of the user's shopping excursion and thereby narrow the focus of the application 132 and limit the types of product categories available for selection by the user.

In further exemplary embodiments, a user may designate one or more product categories by inputting a list of specific products, e.g., representative of the types of products that the user wishes to purchase. The product recommendation application 132 may then be configured to analyze the inputted list of products and automatically infer from the list of products one or more product categories. In exemplary embodiments, the list of products inputted may include products that are of high value or importance to purchase. In some embodiments, the list of products inputted may include products that the user already possesses and wishes to augment. The use of a list of products may be implemented for example as part of a decision tree model or the like for determining the purpose(s) of the user's shopping excursion and thereby narrow the focus of the application 132 and limit the types of product categories available for selection by the user.

In exemplary embodiments, the user interface 136 and product recommendation application may be configured to allow a user input relating to specific product types implicated by a designated product category. Thus, once a user has designated a product category, for example, for furnishing the living room, the user may, in exemplary embodiments, be presented with an opportunity to add or remove product types (such as in the event that the user already has a couch) implicated by that product category. The user may also be allowed to indicate a level of importance (weighting factors) for specific product types and/or for the product category in general. These weighting factors may then be considered in querying the recommended products. In some embodiments, the user may remove and/or add product types by removing and/or adding to the recommended products after the query has already been conducted. In such embodiments, the application 132 may be configured to automatically or upon further user input re-run the query excluding the removed product type and/or including the added product type. The process of re-running a query based on a user modifying the recommended products or initial search criterion is also referred to herein as re-budgeting and advantageously provides feedback, e.g., in real time on how, for example, such changes impact the recommended products.

As noted above, the user interface 136 can be configured and/or programmed to enable user 140 to designate budget criterion 212 as input by the user 140. Budget criterion 212 may, for example, be entered, modified and/or removed by the user 140 using GUI elements of the user interface 136, and/or stored in the data 134. Exemplary GUI elements which may be used include text boxes, sliders, pull down menus, check boxes and the like.

In exemplary embodiments, the budget criterion 212 may include, for example, a maximum price the user 140 desires or is willing to pay for all of the recommended product. In further exemplary embodiments, the budget criterion may include, for example, a range of acceptable prices the user 140 is willing to pay for all of the recommended products. This may be useful in allowing the user to visualize how the various points along the range impact the recommended products. In further exemplary embodiments a budget may be automatically computed, for example, via information received relating to an decision tree model or based on a calculator algorithm. A simple example of this is automatically calculating the budget for a dinner party based on the price per head and the number of people attending. A more complex example of this is automatically calculating the budget for furnishing a dorm room based on a total budget amount minus an anticipated amount required for purchasing books and/or school supplies (in the case that the user wants to focus only on the dorm room, or where the user is unsure of what specific classes he or she is taking and hence is unable to know in advance what books and/or school supplies he or she will be needing). Notably, the application 132 may be configured to automatically calculate a rough budget for each of the different shopping purposes thereby allowing the user 140 to focus on each one separately (at least at first) while maintaining roughly appropriate budgets across the board.

With reference still to FIG. 2, the user interface 136 may further include a control button 214 for initiating the query and/or activating other features of the product recommendation application 132, such as described herein. In some embodiments, if the user 140 presses the control button 214, the query is initiated based at least in part on the inputted product category criterion 210 and the inputted budget criterion 212. The application 132 may then be configured to display, via the user interface 200, a list of recommended items 310 having a total price that is within the budget of the user 140. See FIG. 3 depicts a list of recommended items 310. The list of recommended items 310 is generated by the application 132 based on the data stored in the inventory database 112, and may include specific items in the store inventory that match the designated one or more product categories. For example, if a category was furnishing the living room items including in the recommended products may include a lamp, a rug, a coffee table, etc. The list of recommended items 310 may further include a picture, name, descriptions, quantity and/or price of each recommended item, and the total price of all of the recommended items 310. In exemplary embodiments, the total price may not exceed the designated budget, however it may be less than the budget. In some embodiments, the total price may reflect sale or discount (for example, coupon or instant savings) prices for one or more of the recommended items 310.

FIG. 3 also depicts a user control element 320 that is configured to allow the user 140, via the user interface 200, to increase or decrease the budget 212, for example, using a slider 322 or other type of user control. At various intervals, the user control element 320 may indicate at the extremities the minimum and maximum total prices and may include intermediate total prices at relative positions on the user control element 320 for different combinations of items satisfying the designated product category criterion. More particularly, in exemplary embodiments, the selection of a product category may require purchase of a set of one or more product types, for example, a lamp, a rug and a coffee table. There may be many possible combinations of specific products that would satisfy the set of product types required by the designated product category and each of these combinations may be reflected at particular intervals along element 320. The reason for the many possible combinations is even if, as in a simple case, the product types implicated by the designated product category are not allowed to change (such as with changes to the budget), for any required product type there may still exist, in the inventory of the retailer 110, a variety of products having different prices. Thus, embodiments disclosed herein advantageously enable the user 140 to make informed choices about which specific products to purchase within the designated budget 212 based on the prices of the recommended products. In some embodiments, the inventory database 112 may include products available for purchase online, such as through an electronic commerce website.

In some embodiments, the product types implicated by a designated product category may not be fixed and rather may depend on a variety of other factors such other product category designations, further user input (such as related to weighting factors, or added/removed products/product types), data mining information, for example, related to the user, the user's budget flexibility, and/or the budget itself (for example, with certain combinations of product types corresponding to certain budget ranges). As noted above, various algorithms/techniques may be used to process the query including for example vertical querying, horizontal querying, regression techniques, applying a decision tree model, applying a neural network model, applying machine learning techniques such as support vector machines (SVM) and the like. In exemplary embodiments, a distributed architecture may be used to optimize processing efficiency/speed. In exemplary embodiments, the processing of the query may include determining/optimizing the set of product types implicated by the search criterion and/or determining/optimizing the set of recommended products within the designated budget. Optimization may include rating the sets of recommended products and/or the sets of implicated product types, for example, based on popularity, compatibility, data mining information about the user, for example about the user's likes and dislikes, further user input, other designated product categories, etc.

With reference again to FIG. 3, in some embodiments, the slider 322 may be moved along the user control element 320 to select specific values for the shopping budget 212. For example, by moving the slider 322 in one direction, the budget 212 decreases; by moving the slider 322 in the opposite direction, the budget 212 increases. In this manner, the user 140 can change and adjust the budget 212 using a single input action, such as dragging the slider 322 with a pointing device (for example, a mouse) or using his or her finger, if the user interface 136 includes a touch-receptive input device.

As noted above, as the shopping budget 212 is adjusted by the user 140, the product recommendation application 132 may automatically change the recommended items 310 to correspond with the adjusted budget 212. For example, if the budget 212 increases, the product recommendation application 132 may, for example, update the list of recommended items 310 to include one or more products that are more expensive than the previously recommended products, while keeping the total price of all recommended items within the adjusted shopping budget 212. Alternatively, the product recommendation application may change the set of product types implicated by a designated product category or designated product categories. For example, a more expensive budget may allow for the purchase of additional furnishings rather than simply more expensive furnishings. In contrast, a decrease in budget 212 may result in different, for example, fewer or less expensive recommended products

In this manner, the user 140 can view different sets of product recommendations simply by adjusting the budget 212, and see a display of specific products satisfying the imputed product category criterion 210 that can be purchased for the selected budget 212 before entering the retailer 110 or purchasing the goods online.

In exemplary embodiments, a user may modify (for example, add or remove) one or more products from the recommended products and/or one or more product types from a set of product types implicated by the designated one or more product categories. This may be done prior to the initial query or during a further iteration. Thus, in some embodiments, a user may modify a recommended products list 310, for example, by adding products, deleting products, substituting products such as for a more expensive product or a less expensive product, rating products, such as, in terms of importance, desirability, and the like, locking certain products into place, adding additional discount information (such as coupon codes), changing the quantity of products, and other forms of user input regarding the recommended products list 310. Further iterations of the query may then be run based on the changed parameters involving the previous recommended products list and a new more optimal recommended products list may be generated.

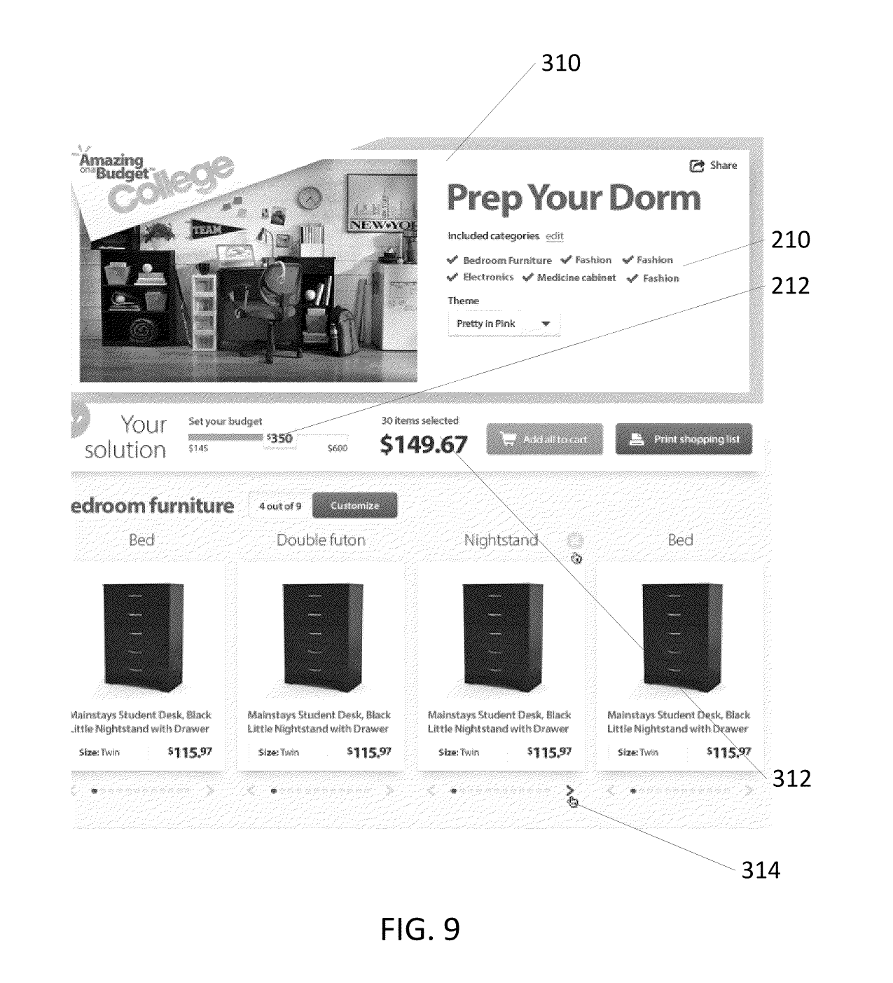

FIG. 9 depicts an exemplary recommended products list 310 for a designated set of product categories 210 and budget 212. The recommended products list 310 of FIG. 9 is an illustrated example of a products list 310 in FIG. 3. In the illustrated recommended products list of FIG. 9, the budget is notably adjustable using a sliding scale, for example similar to the sliding scale of FIG. 3, which will automatically update the recommended products. The total price 312 for the recommended products is also displayed. Images of the recommended products may also be displayed.

Recommended products may be substituted for alternative products using a selection control 314, for example a carousel like control for scrolling though possible products for a given product type. Images of alternative products may be previewed using the selection control 314.

In some embodiments, the list of recommended items 310 may include an aisle locator indicating which aisle in the retailer 110 each recommended item 310 can be found. The information for displaying aisle location may, for example, be retrieved by the product recommendation application 132 from the inventory database 112 or another database.

In some embodiments, one or more items in the list of recommended items 310 includes items available from sources other than, or instead of, the retailer 110. For example, the list of recommended items 310 may include one or more items available for purchase from an online (for example, e-commerce) source if those items are less expensive when purchased from the online source than in the retailer 110. In some embodiments, the user may elect to purchase one or more of those items online and either have it shipped to his or her address or in some instances request that the purchased product(s) be sent to the retailer 110 for delivery to the user. Any shipping costs and time constraints may be taken into account by the applications when generating the list of recommended items 310.

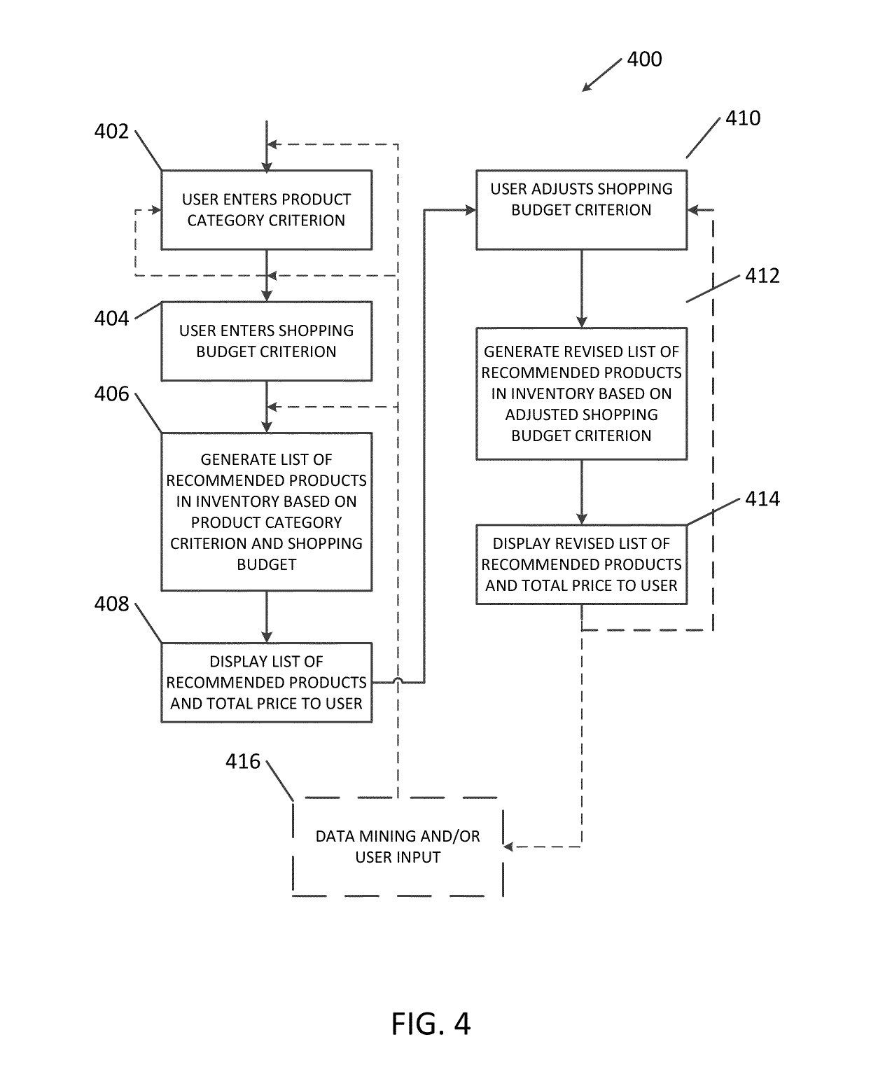

FIG. 4 is a flow diagram of an example of a process 400 for recommending items, for example, for implementation by way of a products recommendation application, accordingly to the present disclosure, for example, product recommendation application 132 of FIG. 1. At step 402, a user designates one or more product categories, for example, by selecting product category criterion such as the product category criterion 210 described above with respect to FIG. 2. The user may designate one or more product categories using a computing device (for example, computing device 130 of FIG. 1) via a user interface (for example, user interface 136 of FIG. 1) using a keyboard, touch screen or other input device. The selected categories may each implicate one or more product types that the user wishes to purchase while shopping at a retailer, such as the retailer 110 described above with respect to FIG. 1. In exemplary embodiments, the user may designate one or more product categories by selecting a solution associated with a predetermined group of one or more product categories. In exemplary embodiments, a user may repeat the step of selecting one or more categories, for example, to add, remove or modify one or more categories.

At step 404, the user enters budget criterion, for example, the budget criterion 212 described above with respect to FIG. 2, such as a maximum dollar amount the user desires or is willing to spend on all of the recommended products. At step 406, a list of recommended products from an inventory of the retailer is generated based on the designated one or more product categories (for example, based on a set of or more product types corresponding to the designated product categories), the prices of the products in inventory, and/or the shopping budget. For example, the list of recommended items may be generated by selecting the lowest priced products from the inventory that match the set of product types implicated by the designated product categories such that the total price of all selected products is within the shopping budget. If the budget can not be met for all implicated product types, in exemplary embodiments, at least one item type can be automatically removed such that the budget can be met for the remaining implicated product types. The one or more items may, for example, be automatically removed based on any number of different criteria, for example, the user's purchase history (for example, the least frequently viewed item may be removed), or based on the price of any recommended product (for example, remove the fewest number of items to stay within the shopping budget) or based on popularity or data mining information. The user can also be requested to provide input regarding removing a product or product type. Alternative configurations of product types may also be considered (for example, substituting a futon for a couch, chair or bean bag, when furnishing a dorm room).

In exemplary embodiments, the user may select one or more preferred products (for example, identified by brand name and/or product name) which may or may not correspond to the one or more product types implicated by the designated one or more product categories. In some embodiments, the one or more preferred products are necessarily included in the list of recommended items instead of the lowest priced products if the total price of all of the products in the list of recommended items is within the shopping budget. In some embodiments, the product types implicated by the one or more preferred products are necessarily included in the set of product types implicated by the designated one or more product categories. In some embodiments, the one or more product categories may be inferred from the preferred products. In exemplary embodiments, the preferred products can be determined using historical data, for example, data representing products previously purchased by the user 140. In some embodiments, the list of recommended items may be generated by selecting the highest priced products from the inventory that satisfy a set of product types implicated by the designated one or more product categories such that the total price of all recommended products is within the shopping budget. At step 408, the list of recommended items is displayed to the user via, for example, the user interface.

In some embodiments, the difference between the lowest priced set of products and the highest priced set of products defines a range of prices that the user can spend to purchase a set of products corresponding to a set of product types implicated by the designated one or more product categories. At step 410, the user may adjust the shopping budget using, for example, the slider 322 of FIG. 3 to increase or decrease the shopping budget within the range of prices. At step 412, a revised list of recommended products in the inventory is generated based on the designated product category criterion, the prices of the products in inventory, and/or the adjusted shopping budget. For example, the list of recommended items may be generated by selecting one or more lower or higher priced products from the inventory that match each of the product types in a set of product types implicated by the designated one or more product categories such that the total price of all selected products is within the adjusted shopping budget. At step 414, the revised list of recommended items is displayed to the user via, for example, the user interface 136. In exemplary embodiments, steps 410, 412 and 414 may be repeated one or more times if, for example, the user wishes to view what effect adjustments to the shopping budget has on the list of recommended items.

At various stages in the process 400 data mining information and/or user input 416 may be used to augment the user experience and/or optimize the process. For example, data mining information and/or user input 416 may be utilized to help identify/characterize the purpose of the user's shopping trip. Thus, for example a decision tree model may be employed to determine that the purpose of a user's shopping trip is to furnish the user's apartment and that the apartment is the user's first apartment and is a one bedroom one bathroom studio apartment. Data mining may also identify the user as a female in her early twenties who loves the color blue and has previously purchased products that are contemporary or modern in style. Thus, user input and/or data mining may be used to automatically select certain product categories of interest, present recommended product categories to the user for easy selection and/or otherwise focus/limit the user's selection choices. In some embodiments, by initially identifying/characterizing the user's purpose the user may then be presented with a customized user interface for selecting one or more product categories. In exemplary embodiments, the user may be presented with one or more customized solutions, each representing one or more product categories selected automatically based on the user input and/or data mining. For example, the user in the above studio apartment example may be presented with one or more customized solutions for furnishing her studio apartment. An example solution may include a set of product categories such as, studio apartment furniture, bathroom supplies, kitchen utensils, cookware and small appliances, and space-saving products. The grouping of product categories may be determined at least in part based on the user input and/or data mining.

In exemplary embodiments, data mining information and/or user input 416 may be utilized to identify/characterize a user's budget including budget flexibility, etc. and or to of the user's shopping trip.

In exemplary embodiments, data mining information and/or user input 416 may be utilized to identify/characterize desired, required or optimal product characteristics for the recommended products. Data mining and/or user input 416 regarding desired, required, or optimal product characteristics may be used to limit which products are included as recommended products and or to rank/compare different recommended product lists.

In exemplary embodiments, data mining information and/or user input 416 may be utilized to modify, add or remove one or more designated product categories. This may impact the recommended products, for example, an added product category may require lower priced products to be recommended for the previously implicated product types to allow for budgeting for newly implicated product types.

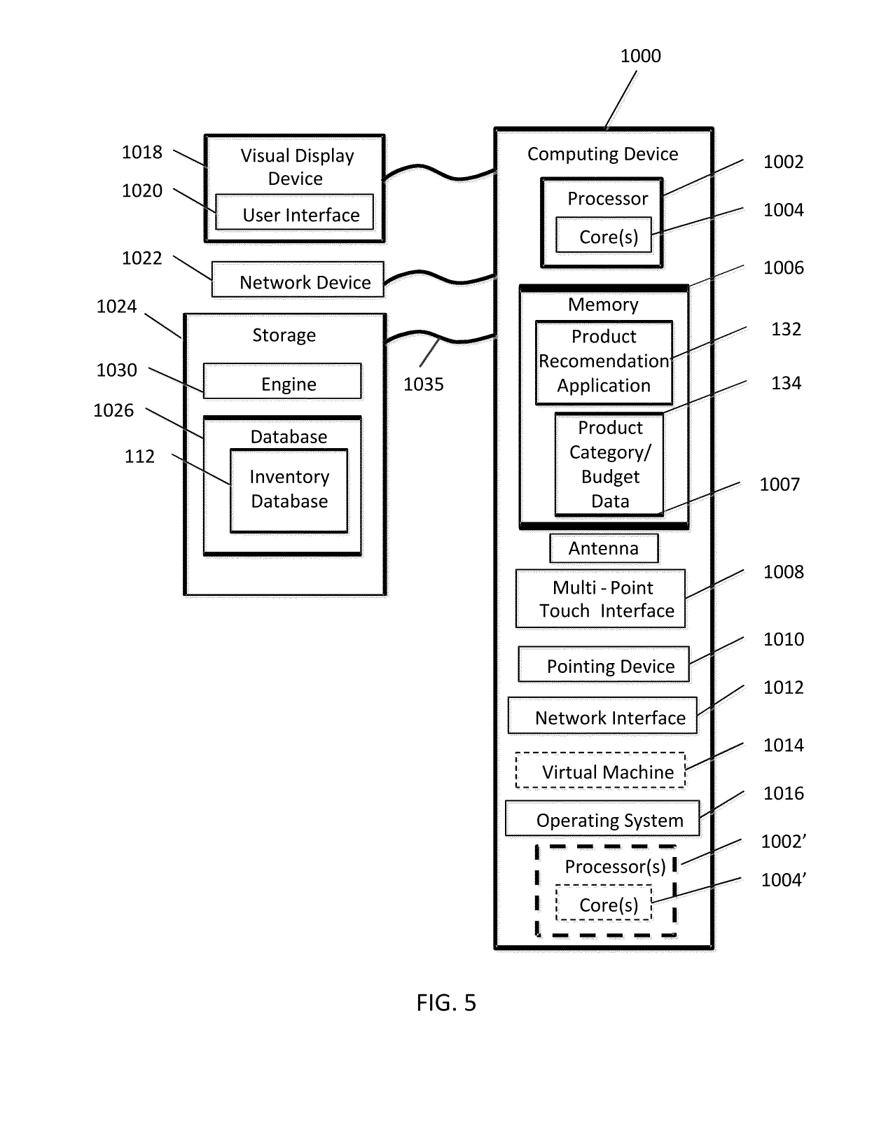

FIG. 5 is a block diagram of an exemplary computing device 1000 that may be used to implement exemplary embodiments described herein. The computing device 1000 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1006 included in the computing device 1000 may store non-transitory computer-readable and computer-executable instructions or software for implementing exemplary embodiments, such as process 400 of generating the list of recommended items, the product recommendation application 132 and/or the product category/budget data 134 of FIG. 1. The computing device 1000 may also include an antenna 1007, for example, for wireless communication with other computing devices via the network 120 of FIG. 1. The computing device 1000 also includes configurable and/or programmable processor 1002 and associated core 1004, and optionally, one or more additional configurable and/or programmable processor(s) 1002′ and associated core(s) 1004′ (for example, in the case of computer systems having multiple processors/cores), for executing non-transitory computer-readable and computer-executable instructions or software stored in the memory 1006 and other programs for controlling system hardware. Processor 1002 and processor(s) 1002′ may each be a single core processor or multiple core (1004 and 1004′) processor.

Virtualization may be employed in the computing device 1000 so that infrastructure and resources in the computing device may be shared dynamically. A virtual machine 1014 may be provided to handle a process running on multiple processors so that the process appears to be using only one computing resource rather than multiple computing resources. Multiple virtual machines may also be used with one processor.

Memory 1006 may include a computer system memory or random access memory, such as DRAM, SRAM, EDO RAM, and the like. Memory 1006 may include other types of memory as well, or combinations thereof.

A user may interact with the computing device 1000 through a visual display device 1018, such as a computer monitor or touch screen display integrated into the computing device 1000, which may display one or more user interfaces 1020 (for example, the user interface 136 of FIG. 1) that may be provided in accordance with exemplary embodiments. The computing device 1000 may include other I/O devices for receiving input from a user, for example, a keyboard or any suitable multi-point touch interface 1008, a pointing device 1010 (for example, a mouse). The keyboard 1008 and the pointing device 1010 may be coupled to the visual display device 1018. The computing device 1000 may include other suitable conventional I/O peripherals.

The computing device 1000 may also include one or more storage devices 1024, such as a hard-drive, CD-ROM, or other non-transitory computer-readable media, for storing data and non-transitory computer-readable instructions and/or software that implement exemplary embodiments described herein. The storage devices 1024 may be integrated with the computing device 1000. The computing device 1000 may communicate with the one or more storage devices 1024 via a bus 1035. The bus 1035 may include parallel and/or bit serial connections, and may be wired in either a multi-drop (electrical parallel) or daisy-chain topology, or connected by switched hubs, as in the case of USB. Exemplary storage device 1024 may also store one or more databases 1026 for storing any suitable information required to implement exemplary embodiments. For example, exemplary storage device 1024 can store one or more databases 1026, including the inventory database 112 of FIG. 1, for storing information, such as inventory data, product category data, shopping budget data and/or any other information. The storage device 1024 can also store an engine 1030 including logic and programming for receiving the user input parameters and outputting one or more recommended items based on the input parameters, for performing one or more of the exemplary methods disclosed herein.

The computing device 1000 can include a network interface 1012 configured to interface via one or more network devices 1022 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 1012 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein. Moreover, the computing device 1000 may be any computer system, such as a workstation, desktop computer, server, laptop, handheld computer, tablet computer (for example, the iPad® tablet computer), mobile computing or communication device (for example, the iPhone® communication device), or other form of computing or telecommunications device that is capable of communication and that has sufficient processor power and memory capacity to perform the operations described herein.

The computing device 1000 may run any operating system 1016, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 1016 may be run in native mode or emulated mode. In an exemplary embodiment, the operating system 1016 may be run on one or more cloud machine instances.

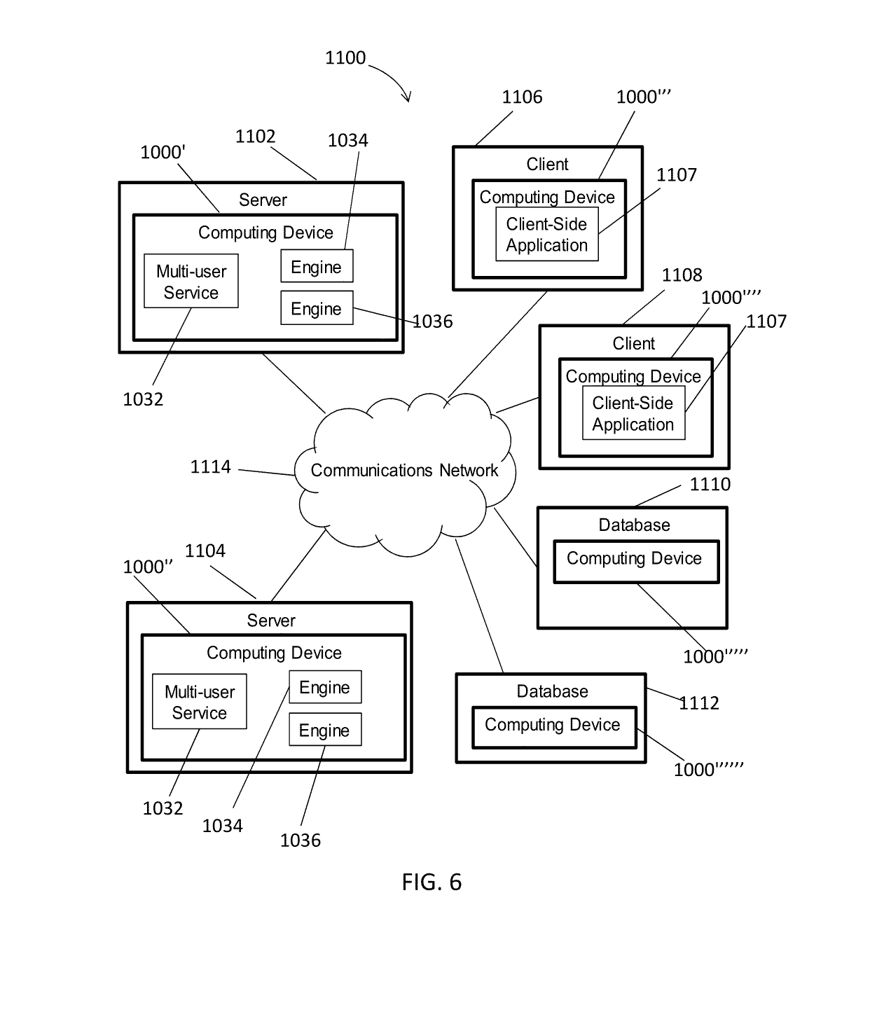

FIG. 6 is a block diagram of an exemplary network environment 1100 suitable for a distributed implementation of exemplary embodiments. The network environment 1100 may include one or more servers 1102 and 1104, one or more clients 1106 and 1108, and one or more databases 1110 and 1112, each of which can be communicatively coupled via a communication network 1114, such as the network 120 of FIG. 1. The servers 1102 and 1104 may take the form of or include one or more computing devices 1000′ and 1000″, respectively, that are similar to the computing device 1000 illustrated in FIG. 5. The clients 1106 and 1108 may take the form of or include one or more computing devices 1000′″ and 1000′″, respectively, that are similar to the computing device 1000 illustrated in FIG. 5. For example, clients 1106 and 1108 may include mobile user devices. Similarly, the databases 1110 and 1112 may take the form of or include one or more computing devices 1000′″″ and 1000″″″, respectively, that are similar to the computing device 1000 illustrated in FIG. 5. While databases 1110 and 1112 have been illustrated as devices that are separate from the servers 1102 and 1104, those skilled in the art will recognize that the databases 1110 and/or 1112 may be integrated with the servers 1102 and/or 1104 and/or the clients 1106 and 1108.

The network interface 1012 and the network device 1022 of the computing device 1000 enable the servers 1102 and 1104 to communicate with the clients 1106 and 1108 via the communication network 1114. The communication network 1114 may include, but is not limited to, the Internet, an intranet, a LAN (Local Area Network), a WAN (Wide Area Network), a MAN (Metropolitan Area Network), a wireless network, an optical network, and the like. The communication facilities provided by the communication network 1114 are capable of supporting distributed implementations of exemplary embodiments.

In exemplary embodiments, one or more client-side applications 1107 may be installed on client 1106 and/or 1108 to allow users of client 1106 and/or 1108 to access and interact with a multi-user service 1032 installed on the servers 1102 and/or 1104. For example, the users of client 1106 and/or 1108 may include users associated with an authorized user group and authorized to access and interact with the multi-user service 1032. In some embodiments, the servers 1102 and 1104 may provide client 1106 and/or 1108 with the client-side applications 1107 under a particular condition, such as a license or use agreement. In some embodiments, client 1106 and/or 1108 may obtain the client-side applications 1107 independent of the servers 1102 and 1104. The client-side application 1107 can be computer-readable and/or computer-executable components or products, such as computer-readable and/or computer-executable components or products for presenting a user interface for a multi-user service. One example of a client-side application is a web browser that allows a user to navigate to one or more web pages hosted by the server 1102 and/or the server 1104, which may provide access to the multi-user service. Another example of a client-side application is a mobile application (for example, a smart phone or tablet application, such as the product recommendation application 132 of FIG. 1) that can be installed on client 1106 and/or 1108 and can be configured and/or programmed to access a multi-user service implemented by the server 1102 and/or 1104.

The databases 1110 and 1112 can store user information, inventory data and/or any other information suitable for use by the multi-user service 1032. The servers 1102 and 1104 can be programmed to generate queries for the databases 1110 and 1112 and to receive responses to the queries, which may include information stored by the databases 1110 and 1112.

Having thus described several exemplary embodiments of the disclosure, it is to be appreciated various alterations, modifications, and improvements will readily occur to those skilled in the art. For example, some embodiments can be applied to inventories of grocery items or other saleable items. Accordingly, the foregoing description and drawings are by way of example only.

What is claimed is:

1. A computer-implemented method for interactive shopping, the method comprising:
providing a downloadable user interface executable on a mobile electronic device, the user interface being programmed to:
display user controls for receiving user input for designating one or more product categories and a budget; and.
display a list of recommended products selected from an inventory of products and corresponding to a set of product types implicated by the designated one or more product categories, with a total price of the recommended products being within the maximum price of the budget.

2. The computer-implemented method of claim 1, wherein user controls displayed in conjunction with the displayed recommended products are operable to increase or decrease the shopping budget within a predetermined range of prices in response to user manipulation of thereof.

3. The computer-implemented method of claim 2, wherein the predetermined range of prices includes a total selling price of a least-expensive set of recommended products corresponding to the set of product types implicated by the designated one or more product categories and a total selling price of a most-expensive set of recommended products corresponding to the set of product types implicated by the designated one or more product categories.

4. The computer-implemented method of claim 2, wherein the user interface is further configured to display an updated list of recommended products in response to an increase or decrease in the shopping budget, wherein the total selling price of the recommended products in the updated list is within the increased or decreased shopping budget.

5. The computer-implemented method of claim 4, wherein the updated list includes an automatic substitution of at least one of the recommended products with at least one other product of a same product type, from the inventory of products, having a different selling price, sales volume, brand name, quantity, size and/or weight than the substituted product.

6. The computer-implemented method of claim 4, wherein the updated list includes a substitution of at least one of the recommended products in the list with at least one other product of a same product type, in the inventory of products, having a different selling price than the substituted product, the different selling price including a coupon savings or discounted amount.

7. The computer-implemented method of claim 1, wherein the user interface is further programmed to display in-store aisle location information associated with at least one of the recommended products.

8. The computer-implemented method of claim 1, further comprising storing, in one or more non-transitory computer-readable storage media, product category and product type information for each of the products in the product inventory.

9. The computer-implemented method of claim 1, further comprising storing, in the one or more non-transitory computer-readable storage media, a shopping budget data structure for storing budget data representing the shopping budget.

10. A computer-implemented method for interactive shopping, the method comprising:
generating, by the processor and from an inventory of products for sale at a retailer, a list of recommended products corresponding to a set of product types implicated by one or more designated product categories, a total selling price of the recommended products being within a designated shopping budget; and
displaying, using the user interface, the list of recommended products.

11. The computer-implemented method of claim 10, further comprising updating the shopping budget in response to user manipulation of a user control, the user control being operable to increase or decrease the shopping budget within a predetermined range of prices.

12. The computer-implemented method of claim 11, wherein the predetermined range of prices includes a total selling price of a least-expensive set of recommended products corresponding to the set of product types implicated by the designated one or more product categories and a total selling price of a most-expensive set of recommended products corresponding to the set of product types implicated by the designated one or more product categories.

13. The computer-implemented method of claim 11, further comprising updating the list of recommended products subsequent to updating the budget data, such that the total selling price of the recommended products in the updated list is within the increased or decreased shopping budget.

14. The computer-implemented method of claim 13, further comprising displaying, using the user interface, the updated list of recommended products.

15. The computer-implemented method of claim 13, wherein the updated list of recommended products includes a substitution of at least one of the recommended products with at least one other product of a same product type, in the inventory of products, having a different selling price, sales volume, brand name, quantity, size and/or weight than the substituted product.

16. The computer-implemented method of claim 13, wherein the updated list of recommended products includes a substitution of at least one of the recommended products in the list with at least one other item of a same product type, in the inventory of products, having a different selling price than the substituted product, the different selling price including a coupon or discounted amount.

17. The computer-implemented method of claim 10, further comprising displaying, using the user interface, in-store aisle location information associated with at least one of the recommended products.

18. An interactive shopping system comprising:
a processor; and
a memory operatively coupled to the processor,
the processor being configured to be operatively coupled to a network and to receive data from and send data to a mobile electronic device via the data communication network,
wherein the memory includes processor-readable instructions that when executed by the processor cause the processor to:
receive from the mobile device data for designating one or more product categories and a shopping budget;
generate, from an inventory of products for sale at a retailer, a list of recommended products corresponding to a set of product types implicated by the one or more designated product categories, a total selling price of the recommended products being within the designated shopping budget; and
forwarding for display on a user interface of the mobile device, the list of recommended products.

19. The system of claim 18, wherein the memory further includes instructions that when executed by the processor cause the server to update the shopping budget in response to user manipulation of a user control, the user control being operable to increase or decrease the shopping budget within a predetermined range of prices.

20. The system of claim 19, wherein the user control includes a virtual slider control.

21. The system of claim 19, wherein the predetermined range of prices includes a total selling price of a least-expensive set of recommended products corresponding to the set of product types implicated by the designated one or more product categories and a total selling price of a most-expensive set of recommended products corresponding to the set of product types implicated by the designated one or more product categories.

22. The system of claim 21, wherein the memory further includes instructions that when executed by the processor cause the server to update the list of recommended products subsequent to updating the budget data, such that the total selling price of the recommended products in the updated list is within the increased or decreased shopping budget.

23. The system of claim 22, wherein the memory further includes instructions that when executed by the processor cause the server to forward for display, using the user interface, the updated list of recommended products.

24. The system of claim 22, wherein the updated list of recommended products includes a substitution of at least one of the recommended products with at least one other product of a same product type, in the inventory of products, having a different selling price, sales volume, brand name, quantity, size and/or weight than the substituted product.

25. The system of claim 22, wherein the updated list of recommended products includes a substitution of at least one of the recommended products in the list with at least one other item of a same product type, in the inventory of products, having a different selling price than the substituted product, the different selling price including a coupon or discounted amount.

26. The system of claim 18, wherein the memory further includes instructions that when executed by the processor cause the server to forward for display, using the user interface, in-store aisle location information associated with at least one of the recommended products.

27. A non-transitory computer-readable medium having stored thereon computer-executable instructions that when executed by a computer cause the computer to
receive data for designating one or more product categories and a shopping budget; and
generate, from an inventory of products for sale at a retailer, a list of recommended products corresponding to a set of product types implicated by the one or more designated product categories, a total selling price of the recommended products being within the designated shopping budget; and.

28. The non-transitory computer-readable medium of claim 27, further having instructions that when executed by the computer cause the computer to:
update the budget data in response to user manipulation of a user control, the user control being operable to increase or decrease the shopping budget within a predetermined range of prices; and
update the list of recommended products such that the total selling price of the recommended products in the updated list is within the increased or decreased shopping budget.
